(19) United States
(12) Patent Application Publication
(10) Pub. No.: US 2016/0146150 A1
(43) Pub. Date: May 26, 2016

(54) EXHAUST MANIFOLD-INTEGRATED CYLINDER HEAD WITH WATER JACKET

(71) Applicants: HYUNDAI MOTOR COMPANY, Seoul (KR); KIA MOTORS CORPORATION, Seoul (KR)

(72) Inventors: Oh Young SONG, Hwaseong-si (KR); Seonyeong KIM, Incheon (KR); Minkyu PARK, Yongin-si (KR)

(21) Appl. No.: 14/814,032

(22) Filed: Jul. 30, 2015

(30) Foreign Application Priority Data
Nov. 26, 2014 (KR) 10-2014-0166791

(51) Int. Cl. F02F 1/24; F02F 1/10

(52) U.S. Cl. CPC F02F 1/243; F02F 1/242; F02F 1/10

(57) ABSTRACT

An exhaust manifold-integrated cylinder head with a water jacket includes intake ports through which outside air is supplied and exhaust ports through which exhaust gas is discharged. Intake valve holes and exhaust valve holes open the intake ports and the exhaust ports. Spark plug holes are formed on a top side of the cylinder head. A head water jacket is formed within the cylinder head to allow a coolant to flow from one end to another end. The head water jacket includes exhaust port bridge coolant passages formed between the exhaust ports. Lower coolant guides protrude inside the cylinder head so that the coolant flows upward from a bottom side of the cylinder head through the exhaust port bridge coolant passages.

### CROSS-REFERENCE TO RELATED APPLICATION

This application claims the benefit of priority to Korean Patent Application No. 10-2014-0166791 filed in the Korean Intellectual Property Office on Nov. 26, 2014, the entire content of which is incorporated herein by reference.

### TECHNICAL FIELD

The present disclosure relates to an exhaust manifold-integrated cylinder head with a water jacket that has a cooling structure capable of improving knocking characteristics and combustion characteristics by reducing temperatures near exhaust ports and spark plugs.

### BACKGROUND

A cylinder block and a cylinder head of a vehicle engine have a water jacket to cool heat generated in a combustion chamber and other mechanically operated parts used for the engine, in order to prevent overheating. The water jacket further maintains an appropriate temperature of the engine to achieve optimum thermal efficiency.

That is, the water jacket allows a coolant passing through to cool heat generated by the engine. Further, more heat is generated at regions near exhaust ports and exhaust valve seats, through which exhaust gases from the engine are discharged in the engine. Thus, it is necessary to form smooth and appropriate coolant flow so as to prevent the heat from being locally concentrated in the cylinder head. In general, a cross-sectional area or rate of coolant flow near the exhaust ports and the exhaust valve seats is almost the same as other regions, thus decreasing cooling efficiency near the exhaust ports and the exhaust valve seats that are subjected to a relatively high thermal load.

Accordingly, high-temperature regions are formed between the exhaust ports and near spark plugs. These high-temperature regions may deteriorate the engine performance, as well durability of the cylinder head and knocking characteristics of the engine.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide an exhaust manifold-integrated cylinder head with a water jacket which can reduce noise/vibration and improve combustion efficiency by maintaining a stable ignition timing, in which knocking characteristics and combustion characteristics are improved by effectively controlling the flow of a coolant passing through a high-temperature regions formed between exhaust ports and near spark plug holes.

According to an exemplary embodiment of the present inventive concept, an exhaust manifold-integrated cylinder head with a water jacket includes intake ports through which outside air is supplied, and exhaust ports through which exhaust gas is discharged from the combustion chamber. Intake valve holes and exhaust valve holes open the intake ports and the exhaust ports. Spark plug holes are formed on a top side of the cylinder head. A head water jacket is formed within the cylinder head to allow a coolant to flow from one end to another end. The head water jacket includes exhaust port bridge coolant passages formed between the exhaust ports. Lower coolant guides protrude inside the cylinder head so that the coolant flows upward from a bottom side of the cylinder head through the exhaust port bridge coolant passages. The head water jacket may include upper bridge coolant passages formed between the exhaust valve holes and the spark plug holes, and upper coolant guides protruding and extending downward from the top side of the cylinder head. The upper bridge coolant passages have a thickness decreasing from the top side to the bottom side in a vertical direction.

The cylinder head has at least two exhaust valve holes. Each upper coolant guide may communicate with one of the at least two exhaust valve holes that is formed closer to a coolant inlet side than the other one.

The cylinder head has at least two exhaust ports. The lower coolant guides may extend from a coolant outlet side toward an exhaust side and have one end slantly protruding toward the coolant inlet side.

The head water jacket may include an upper head water jacket at an upper side thereof and a lower head water jacket at a lower side thereof below the upper head water jacket. The lower coolant guides correspond to the lower head water jacket, and the upper coolant guides correspond to the upper head water jacket.

The cylinder head may include an integral exhaust manifold, and the head water jacket may include an exhaust manifold water jacket corresponding to the exhaust manifold, the exhaust manifold water jacket including an upper water jacket corresponding to the upper head water jacket and a lower water jacket corresponding to the lower head water jacket.

According to the present disclosure, knocking characteristics and combustion characteristics can be improved by forming lower coolant guides between exhaust ports for guiding a coolant flowing from a coolant inlet side to an exhaust side toward exhaust port bridge coolant passages and effectively cooling high-temperature regions between the exhaust ports.

Further, knocking characteristics and combustion characteristics can be improved by forming upper coolant guides for guiding coolant flowing from the coolant inlet side to the exhaust side toward upper bridge coolant passages between exhaust valve holes and spark plug holes and effectively cooling high-temperature regions formed near spark plugs.

Accordingly, the present disclosure can reduce noise/vibration and improve combustion efficiency by keeping ignition timing stable.

### BRIEF DESCRIPTION OF THE DRAWINGS

FIG. 1 is a view showing one side of an exhaust manifold-integrated cylinder head with a water jacket according to an exemplary embodiment of the present inventive concept.

FIG. 2 is a cross-sectional view of the cylinder head taken along line I-I of FIG. 1.

FIG. 3 is a perspective view of a head water jacket formed within an exhaust manifold-integrated cylinder head according to an exemplary embodiment of the present inventive concept.

FIG. 4 is a perspective view of a head water jacket according to an exemplary embodiment of the present inventive concept.

FIG. 5 is a top plan view showing a partial cross-section of a head water jacket according to an exemplary embodiment of the present inventive concept.

FIG. 6 is a front view showing a partial cross-section of a head water jacket according to an exemplary embodiment of the present inventive concept.

### DETAILED DESCRIPTION OF THE EMBODIMENTS

An exemplary embodiment of the present inventive concept will hereinafter be described in detail with reference to the accompanying drawings.

In an exemplary embodiment of the present inventive concept, an exhaust manifold-integrated cylinder head cools an exhaust manifold through an exhaust manifold water jacket which extends on the exhaust side. As a coolant flows mainly to the exhaust manifold, cooling efficiency near a combustion chamber (exhaust ports or spark plug holes) may be deteriorated.

Accordingly, the coolant needs to flow to the exhaust manifold toward near exhaust ports or spark plug holes.

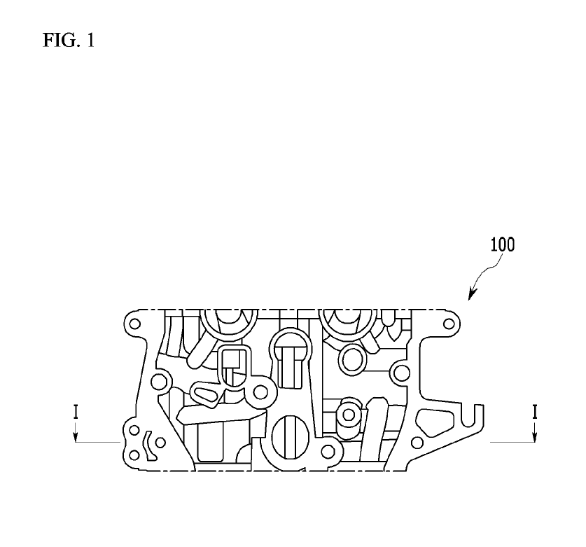

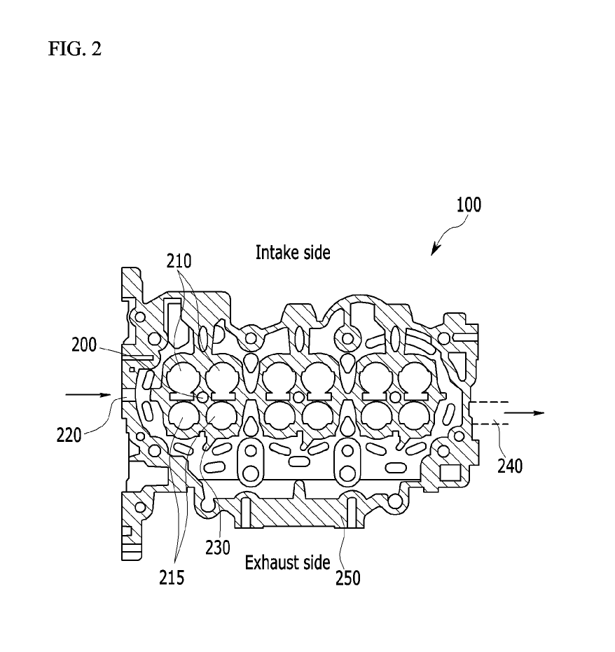

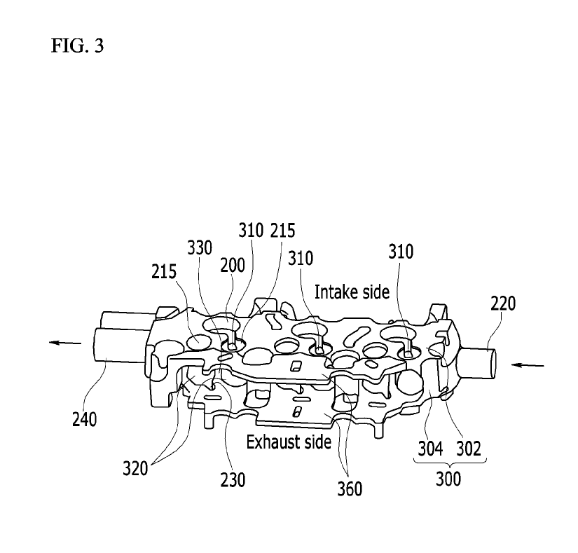

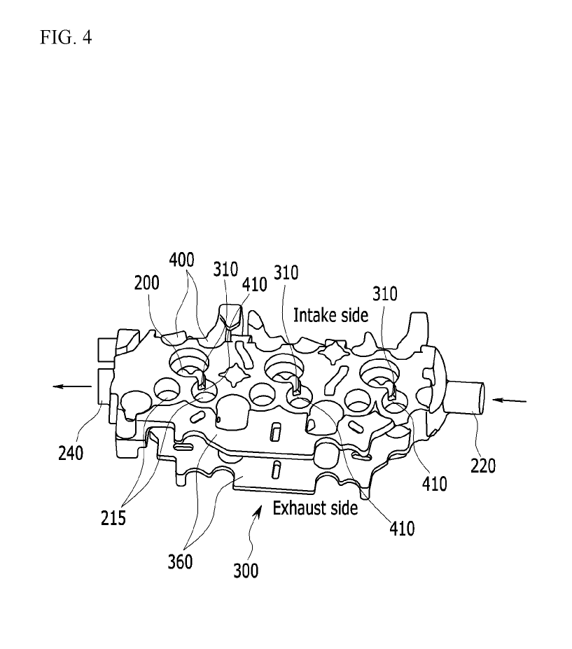

FIG. 1 is a view showing one side of an exhaust manifold-integrated cylinder head with a water jacket according to an exemplary embodiment of the present inventive concept. FIG. 2 is a cross-sectional view of the cylinder head taken along line I-I of FIG. 1. FIG. 3 is a perspective view of a head water jacket formed within an exhaust manifold-integrated cylinder head according to an exemplary embodiment of the present inventive concept. FIG. 4 is a perspective view of a head water jacket according to an exemplary embodiment of the present inventive concept.

Referring to FIGS. 1 to 4, an exhaust manifold-integrated cylinder head 100 is mounted on a top side of a cylinder block (not shown), and a combustion chamber (not shown) is formed within the cylinder block.

The cylinder head 100 and the cylinder block are secured firmly to each other by a head gasket, and held together with bolts (not shown). The exhaust manifold-integrated cylinder head 100 includes a coolant inlet 220 at one end of the cylinder head 100, and a coolant outlet 240 at another end.

The cylinder head 100 is divided by an intake side at one side and an exhaust side at another side with respect to a virtual line passing from the coolant inlet 220 to the coolant outlet 240.

The cylinder head 100 includes an integral exhaust manifold 250. The exhaust manifold 250 is connected to an intake manifold (not shown) for receiving outside air from the intake side to the combustion chamber, and discharges exhaust gas to the exhaust side through exhaust ports 320.

The cylinder head 100 includes intake ports 400 that correspond to each cylinder and supply the outside air to the combustion chamber and exhaust ports 320 that discharge the combusted gases. The cylinder head 100 also includes intake valve holes 210 for opening and closing the intake ports 400, and exhaust valve holes 215 where valves for opening and closing the exhaust ports 320.

The cylinder head 100 further includes spark plug holes 200, each of which corresponding to a center of each cylinder, into which spark plugs (not shown) are inserted and secured.

Referring to FIG. 3, the cylinder head 100 further includes a head water jacket 300 therein, which is integrally connected to an exhaust manifold water jacket 360 of the exhaust manifold 250.

The head water jacket 300 includes an upper head water jacket 302 at an upper side and a lower head water jacket 304 at lower side below the upper head water jacket 302.

The spark plug holes 200 and the exhaust valve holes 215 correspond to spark plugs and exhaust valves (not show) provided in the cylinder head 100. The intake ports 400 and the exhaust ports 320 are formed on the intake side and the exhaust side, respectively, between the upper head water jacket 302 and the lower head water jacket 304.

The cylinder head has two exhaust ports 320 for each cylinder, and an exhaust port bridge coolant passage 330 is formed upwards from a bottom side of the cylinder head 100 between the two exhaust ports 320.

The exhaust port bridge coolant passage 330 vertically connects the lower head water jacket 304 and the upper head water jacket 302 between the exhaust ports 320, thereby improving cooling efficiency in high-temperature regions.

The cylinder head 100 further includes a lower coolant guide 230 protruding to guide the coolant flowing through the lower head water jacket 304 toward the exhaust port bridge coolant passage 330.

Referring to FIG. 4, the cylinder head has two exhaust valve holes 215 and one spark plug hole 200 for each cylinder. An upper bridge coolant passage 410 is formed between one exhaust valve hole 215 provided at a coolant inlet side 220 and the one spark plug hole 200. An upper coolant guide 310 is formed within the cylinder head 100 and protrudes downward, corresponding to the upper bridge coolant passage 410.

The upper coolant guide 310 extends downward from the upper side of the cylinder head 100 in which the upper bridge coolant passage 410 becomes thinner. Accordingly, the rate of coolant flow through the upper bridge coolant passage 410 increases, thereby improving the cooling efficiency in the high-temperature regions between the one spark plug hole 200 and the exhaust valve holes 215.

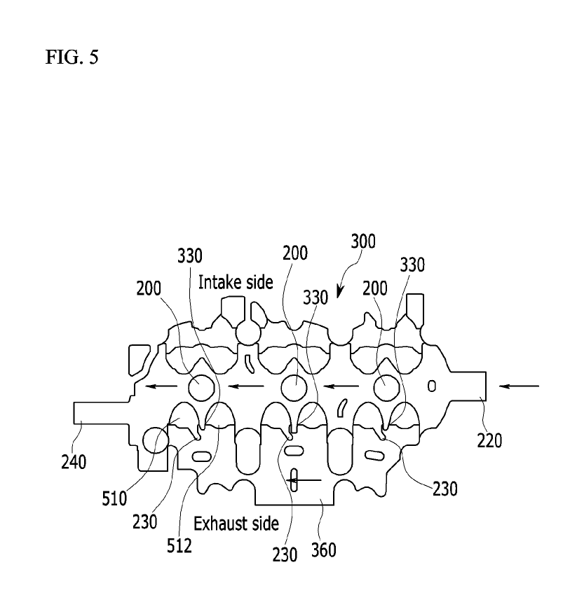

FIG. 5 is a top plan view showing a partial cross-section of a head water jacket according to an exemplary embodiment of the present inventive concept.

Referring to FIG. 5, a first exhaust port 510 is formed at a coolant outlet side 240, corresponding to each cylinder. A second exhaust port 512 is formed at the coolant inlet side 220, adjacent to the first exhaust port 510.

The exhaust port bridge coolant passage 330 is formed upwards from the bottom between the first exhaust port 510 and the second exhaust port 512, and a lower coolant guide 230 protrudes in the first exhaust port 510 so that the coolant moves upward from the bottom through the exhaust port bridge coolant passage 330.

The lower coolant guide 230 slantly extends to the exhaust side toward the coolant inlet side 220. As such, the lower coolant guide 230 guides the coolant flowing from the coolant inlet side 220 to the coolant outlet side 240 to smoothly flow to the exhaust port bridge coolant passage 330.

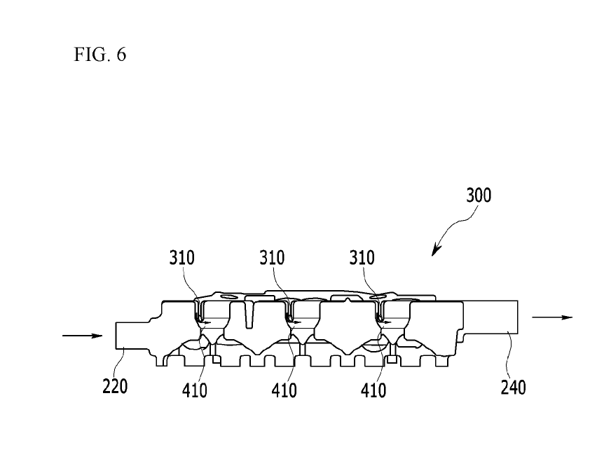

FIG. 6 is a front view showing a partial cross-section of a head water jacket according to an exemplary embodiment of the present inventive concept.

Referring to FIG. 6, a coolant flows from the coolant inlet 220 to the coolant outlet side 240 in the head water jacket 300. The upper coolant guides 310 extend downward from the top in the upper bridge coolant passages 410 formed between spark plug holes 200 and the exhaust valve holes 215.

Accordingly, the cross-sectional area of coolant flow decreases as the coolant flowing in the upper side moves to the lower side by the upper coolant guides 310, thereby sharply increasing the rate of coolant flow. Therefore, the cooling efficiency in the high-temperature regions near the spark plug holes 200 and the exhaust valve holes 215 increases.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. An exhaust manifold-integrated cylinder head with a water jacket, the cylinder head comprising:
intake ports through which outside air is supplied and exhaust ports through which exhaust gas is discharged;
intake valve holes and exhaust valve holes for open the intake ports and the exhaust ports;
spark plug holes formed on a top side of the cylinder head; and
a head water jacket formed within the cylinder head to allow a coolant to flow from one end to another end,
wherein the head water jacket comprising: exhaust port bridge coolant passages formed between the exhaust ports; and lower coolant guides protruding inside the cylinder head so that the coolant flows upward from a bottom side of the cylinder head through the exhaust port bridge coolant passages.

2. The exhaust manifold-integrated cylinder head of claim 1, wherein the head water jacket comprises:
upper bridge coolant passages formed between the exhaust valve holes and the spark plug holes; and
upper coolant guides protruding and extending downward from the top side of the cylinder head,
wherein the upper bridge coolant passages have a thickness decreasing from the top side to the bottom side in a vertical direction.

3. The exhaust manifold-integrated cylinder head of claim 2, wherein the cylinder head has at least two exhaust valve holes, and
each upper coolant guide communicates with one of the at least two exhaust valve holes that is formed closer to a coolant inlet side than the other one.

4. The exhaust manifold-integrated cylinder head of claim 1, wherein the cylinder head has at least two exhaust ports, and
the lower coolant guides extend from a coolant outlet side toward an exhaust side and have one end slantly protruding toward the coolant inlet side.

5. The exhaust manifold-integrated cylinder head of claim 2, wherein the head water jacket comprises:
an upper head water jacket at an upper side thereof and a lower head water jacket at a lower side thereof below the upper head water jacket,
wherein the lower coolant guides correspond to the lower head water jacket and
the upper coolant guides correspond to the upper head water jacket.

6. The exhaust manifold-integrated cylinder head of claim 5, wherein
the cylinder head comprises an integral exhaust manifold, and the head water jacket comprises an exhaust manifold water jacket corresponding to the exhaust manifold,
the exhaust manifold water jacket comprising an upper water jacket corresponding to the upper head water jacket and a lower water jacket corresponding to the lower head water jacket.
